(19) United States
(12) Patent Application Publication
(10) Pub. No.: US 2026/0350408 A1
(43) Pub. Date: Nov. 5, 2026

(54) MULTIMODAL LARGE LANGUAGE MODELS FOR DRIVING

(71) Applicant: VOLKSWAGEN AKTIENGESELLSCHAFT, Wolfsburg (DE)

(72) Inventors: Alireza SHAMSOSHOARA, San Mateo, CA (US); Pedram AGHAZADEH, Mountain View, CA (US)

(21) Appl. No.: 19/194,503

(22) Filed: Apr. 30, 2025

(51) Int. Cl. G06N 3/096

(52) U.S. Cl. CPC G06N 3/096

(57) ABSTRACT

A pretrained multimodal language model is integrated with specific tools specializing in specific capabilities which the pretrained multimodal language model lacks. The pretrained multimodal language model is fine-tuned to operate with the specific tools based on fine-tuning training data generated with a large language model separate from the pretrained multimodal language model. The fine-tuned pretrained multimodal language model receives a multimodal input relating to the specific capabilities which the multimodal language model lacks. The fine-tuned pretrained multimodal language model operates with the specific tools to generate a final output based on the multimodal input received by the fine-tuned pretrained multimodal language model.

### TECHNICAL FIELD

Embodiments relate generally to vehicles, and, more specifically, to multimodal large language models (LLMs) for driving.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Multimodal language models or, more specifically, vision language models (VLMs) have been used recently in different applications such as chatbot. While they have grabbed attention, these models are not suitable in automotive and driving applications. For example, these models are prone to hallucination when they need to answer users'requests. This hallucination can cause faulty answers and responses to be produced, which would be problematic and entail serious consequences for critical applications such as driving.

### BRIEF DESCRIPTION OF DRAWINGS

The present disclosure is illustrated by way of example, and not by way of limitation, in the figures of the accompanying drawings and in which like reference numerals refer to similar elements and in which:

FIG. 1 illustrates an example framework or system in which a fine-tuned pretrained core model interoperates with external tools;

FIG. 2A illustrates example tools, functions, APIs, libraries or applications; FIG. 2B illustrates example operations of a core model; FIG. 2C illustrates an example conversation between a user or agent and the core model operating with tools, functions, APIs, libraries or applications;

FIG. 3 illustrates example operations to generate or create training data for fine tuning the core model in a fine-tuning phase;

FIG. 4 illustrates an example process flow; and

FIG. 5 is block diagram of a computer system upon which embodiments of the disclosure may be implemented.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0. General Overview
2.0. Structural Overview
   2.1. Core Model and Tools
   2.2. Pretraining and Fine-tuning
   2.3. Fine-tuning for Tool Calling
   2.4. Tools and Functions
   2.5. Multimodal Input and Textual Output
   2.6. Multimodal Input and Output
   2.7. Fine-tuning Training Data Generation
3.0. Example Process Flows
4.0. Implementation Mechanism—Hardware Overview
5.0. Extensions and Alternatives

### 1.0. General Overview

Multimodal language models-such as Large Language and Vision Assistant (LLaVa), InternLM, Deepseek, etc.—demonstrate a great capability to understand general information from different domains such image and text. Example LLaVa multimodal language models are described in H. Liu, C. Li, Q. Wu, and Y.J. Lee, “Visual Instruction Tuning,” The 37th Conference on Neural Information Processing Systems (arXiv:2304.08485) (2023), the contents of which are incorporated by reference herein.

Such models are able to answer different questions with respect to images, which may be referred to as visual Q/A. More specifically, these models can be used for generating image captioning to describe different images and for object localization, zero shot segmentation, etc. The models can be trained on the Internet-scaled data covering many texts and images.

Example multimodal language models may be vision language models (VLMs) that can be used to support a number of applications including chatbot applications. While trained broadly and generally with many texts and images, these models are prone to hallucination when they need to answer users'requests related to specific contexts, domains or applications. Because of this hallucination, faulty answers and responses can be generated from these models, which are unsuitable for critical applications or application areas such as vehicle driving.

In comparison, techniques as described herein can be used to provide an overall multimodal language model or VLM that is capable of or trained to call specific (e.g., domain specific, driving specific, vehicle specific, etc.) experts and external tools—based on user or agent questions, requests or inputs—to generate relatively accurate, robust and low level details that are suited for critical applications such as driving. The relatively low level details may include, but are not necessarily limited to, information or data relating to one or more of: lane marking, lane segmentation, traffic light status, traffic sign information, future trajectories, etc.

In particular, the overall multimodal language model or VLM as described herein can be used to answer different questions and provide information relatively quickly to a user or application in connection with an advanced driver assistance system (ADAS) and related vehicle driving operations/applications/tools for autonomous driving mobility and transport.

The overall multimodal language model or VLM can be trained or fine-tuned to operate in conjunction with a range of domain specific experts represented by external tools to cover a range of specific skills or domains such as related to autonomous driving or driving assistance.

As a result, the overall multimodal language model or VLM can be used to make or generate relatively accurate trajectory prediction, which may include detailed explanation for generated output or prediction. In addition, the same overall model can be used to make or generate relatively accurate reading or prediction of applicable speed limits, road conditions, lane marking, lane segmentation, traffic light status, traffic sign information, etc., beyond the trajectory prediction or generation.

Furthermore, the overall multimodal language model or VLM as described herein can include or incorporate with a wide range of other (e.g., more general, etc.) tools (and/or functions, APIs or libraries, applications), which may or may not be specifically related to autonomous driving or driving assistance. For example, the overall multimodal language model or VLM or these other tools can be used to support or perform many real-world tasks such as visual understanding, generation, external knowledge retrieval and their composition, which may or may not be related to vehicle driving. Example experts or tools operating in conjunction with the model as described herein may include, but are not necessarily limited to only, any, some, or all of: Grounding-Dino, semantic segmentations (SAM), image generation (e.g., Pix-to-Pix, etc.), etc.

In some operational scenarios, the overall multimodal LLM or VLM may include a LLaVa-Plus visual language model (VLM) as its core model. Example LLaVa-Plus model(s) are described in S. Liu, H. Cheng, H. Liu, H. Zhang, F. Li, T. Ren, X. Zou, J. Yang, H. Su, J. Zhu, L. Zhang, J. Gao, C. Li, “LLaVa-Plus: Learning to Use Tools for Creating Multimodal Agents,” arXiv:2311.05437v1 [cs.CV] (9 Nov. 2023), the contents of which are incorporated by reference herein.

The core model or VPM can be specifically and additionally trained or fine-tuned, and configured, to call, interface or interoperate with a number of domain specific tools (and/or functions, APIs or libraries, applications) as well as other callable relatively general (e.g., not necessarily domain specific to vehicle driving, etc.) tools (and/or functions, APIs or libraries, applications) so that together these tools with the core model or VPM may be used to support a specific application area/domain such as vehicle driving (e.g., autonomous driving, driving assistance, etc.).

For the purpose of illustration, the LLaVa-Plus model may receive a multimodal input such as a pair of an image and a corresponded prompt from a user or agent. In response to receiving the image and prompt, the LLaVa-Plus model can generate an intermediate response used—e.g., as a query or request, etc.—to call one or more associated or external tools operating in conjunction with (and/or functions, APIs or libraries, applications invocable by) the LLaVa-Plus model.

The associated or external tools are invoked or executed on the image (and the prompt) and returns corresponding intermediate responses or results to the LLaVa-Plus model. The corresponding intermediate responses/results as returned from the associated or external tools (and/or functions, APIs or libraries, applications) can be used by the LLaVa-Plus model to generate a final response, result or output to the user or agent who initially provide the pair of the image and the corresponding prompt as input.

The final response or output, which may represent a summarization of the corresponding intermediate responses or results from the external tools (and/or functions, APIs or libraries, applications), can be used to answer the user or agent's request/query initially made or received by way of the image and the prompt from the user or agent. In some operational scenarios, the final response/result or output can be generated as either a text or a pair of an image (e.g., the original image marked with lane, speed limit, future trajectory, a predicted image relating to a future trajectory, etc.) and a text (e.g., explanatory text, reasoning, etc.), responsive to the user or agent's request/query.

Additionally, optionally or alternatively, some or all of the techniques as described herein may also be implemented with other LLMs such as Mistral 7b v3-instruct (e.g., as a core model, etc.) with or without visual capabilities. For example, such models may be used for vehicle in-cabin applications other than autonomous driving or driving assistance.

Approaches, techniques, and mechanisms are disclosed for operating multimodal language model. A pretrained multimodal language model is integrated with one or more specific tools specializing in one or more specific capabilities which the pretrained multimodal language model lacks. The pretrained multimodal language model is fine-tuned to operate with the one or more specific tools based at least in part on fine-tuning training data generated with a large language model separate from the pretrained multimodal language model. The fine-tuned pretrained multimodal language model receives a multimodal input relating to the one or more specific capabilities which the multimodal language model lacks. The fine-tuned pretrained multimodal language model operates with at least one of the one or more specific tools to generate a final output based at least in part on the multimodal input received by the fine-tuned pretrained multimodal language model.

In other aspects, the disclosure encompasses computer apparatuses and computer-readable media configured to carry out the foregoing techniques.

### 2.0. Structural Overview

An overall multimodal language model or VLM as described herein can be used to prevent hallucinating in a relatively general core model such as a LLaVa-Plus visual language model by integrating external tools trained or pretrained in a range of different domains, applications and contexts with the core model (or VLM) to handle a wide range of requests or queries with different contexts from a user or agent relating to various features or aspects involving a specific model application area.

As used herein, hallucinating (of an artificial intelligence or machine learning model such as a multimodal language model or VLM) refers to producing incorrect answers to requests or queries due to lack of (e.g., domain, application, context, etc.) specific skills, training or pretraining needed to relatively accurately respond or answer requests or queries.

The core model such as a LLaVa-Plus visual language model may not be as specifically trained as compared with the external tools in the specific domains, applications or contexts of the specific model application area such as vehicle driving (e.g., autonomous driving, driving assistance, etc.). Hence, the core model may not answer a user or agent's request or query in the specific application area such as vehicle driving with relatively high reliability, as such request or query may implicate specific contexts, domains or applications for which the core model has not been adequately, competently or completely trained.

In an example, a user may ask what the speed limit is on this road, and a relatively general model (such as the core model alone) without implementing techniques as described herein may give a random answer due to hallucination because the model lacks training or pretraining with respect to speed limit detection or determination.

In another example, a user may ask how many driving lanes exist in the current scene and which lane the car is located on. Since the relatively general model without implementing the techniques as described herein does not have access or training to these specific skills, it may end up with hallucination or failing to answer the question.

Under techniques as described herein, the core model, while has been generally or generically trained (e.g., for image analysis, etc.), can be specifically trained/fine-tuned to interoperate with the external tools in the range of different specific domains, applications or contexts in the specific application area such as relating to vehicle driving or automatic driver assistance systems (ADASs).

Example external tools interoperating with the core model or LLaVa-Plus model may include, but not necessarily limited to only, any, some or all of: traffic sign detection, traffic light detection, speed limit value detection, lane marking detection, lane segmentation, center of lane detection, trajectory generation, etc.

Requests or queries related to ADAS and vehicle driving from a user or agent can be supported or answered with relatively low level details and relatively high level of accuracy or reliability using these external tools interoperating with and accessible to the core model.

For example, in response to receiving a request or query related to ADAS and vehicle driving from a user or agent, the fine-tuned core model can generate intermediate responses with its domain specific capability/accuracy limitations and use the intermediate responses to form one or more corresponding requests or queries to one or more of the external tools, thereby obtaining one or more corresponding responses from the one or more of the external tools operating with the core model. The core model can extract a set of relatively low level details from the one or more corresponding responses received from the one or more of the external tools and form a final response to the user or agent based at least in part on the set of relatively low-level details.

It should be noted that the user may engage in a conversation with the core model in multiple rounds of multimodal inputs from the user and the core model's responses/outputs. In each of the multiple rounds, the user may provide a text only or a multimodal input including both text and image (or video). In each of the multiple rounds, the core model may invoke or call a different group of specific tools in the external tools depending on the user's text or multimodal input specified in the round.

### 2.1. Core Model and Tools

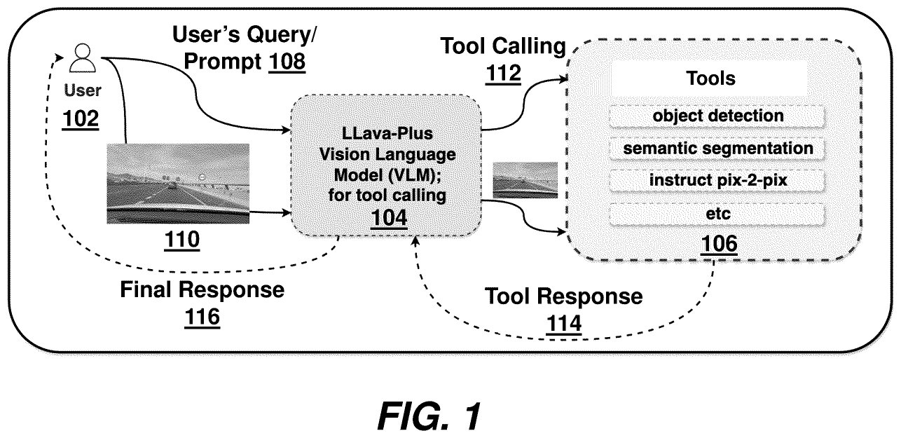

FIG. 1 illustrates an example framework or system in which a fine-tuned pretrained core model 104 interoperates with external tools 106 to provide a relatively complete set of capabilities in a range of specific contexts, domains or applications of a specific application area. For the purpose of illustration only, the specific application area represents an application area for vehicle driving (e.g., autonomous or automatic driving, driver assistance or ADAS, etc.), whereas the range of specific contexts, domains or applications represents specific contexts, domains or applications involved in the vehicle driving. It should be noted, however, that in other operational scenarios, some or all techniques as described herein can be applied to or implemented for other application areas other than vehicle driving.

As shown in FIG. 1, the core model 104 may be implemented as a LLaVa-Plus vision language model (VLM), which may be a pretrained model but further fine-tuned or trained for tool calling. The tools 106 (and/or functions, APIs, libraries or applications) may include, but are not necessarily limited to only, trained or pretrained AI models and/or non-AI modules such as an object detection AI model, a semantic segmentation AI model, an instruct pix-2-pix AI model, etc.

A tool may be implemented or provided with an AI/ML or non-AI tool that has been specifically trained or developed in a specific context, domain or application or across one or more different specific contexts, domains or applications. In an example, the tool may be implemented or provided with an AI/ML tool (or model) that has been specifically trained to acquire specific training or knowledge to generate a relatively accurate response or result based on an input or argument received through the tool's input interface. In another example, the tool may be implemented or provided with a non-AI/ML tool that has been specifically developed to generate a relatively accurate response or result based on an input or argument received through the tool's input interface. In a further example, the tool may be implemented or provided with one or more of AI/ML tools (or models) and/or non-AI/ML tools.

A tool as described herein may be implemented as a specific computer implemented (software and/or hardware) function, API, library, application, module or package that may utilize AI models and/or non-AI models/algorithms/methods/code packages, etc., to perform specific tasks or generate output from (e.g., textual, multimodal, etc.) input or argument received in specific interfaces or formats for the input argument and/or the output. Such a tool may be domain specific or may be domain general or domain agnostic. The result or output generated by the tool implementing a corresponding skill may be relatively accurate or reliable output without hallucination. In response to detecting insufficient information or data in the input or argument to generate a relatively accurate or reliable output or result, the tool can indicate a corresponding error to the caller or invoker such as the core model 104.

In an example, an AI or non-AI tool (and/or function, API or library, application) as described herein may be called or invoked by the core model 104 to provide or return images in its result, response or output. For example, the tool may change an input image depicting a daytime scene as received in input to an output image depicting a corresponding nighttime scene for the same place depicted in the daytime scene. This may be responsive to a query or prompt from a user or (e.g., computer implemented) agent relating to automatic driving mobility and transportation operations to be performed with vehicle(s).

In another example, an AI or non-AI tool (and/or function, API or library, application) as described herein may be called or invoked by the core model 104 to provide or return a (e.g., possible, optimized, etc.) trajectory in its result, response or output. For example, as a part of a multimodal input, a user may provide a prompt, query or question asking the core model 104 what a viable trajectory is, given a current situation as depicted in a scene image provided in the same multimodal input, A specific tool (and/or function, API or library, application) in the tools 106 may be called or invoked by the core model 104 to generate waypoints such as X-Y positions as well as marking these waypoints in the same scene image. The way points may be returned by the core model 104 in a textual output to the user. The same scene image marked with the trajectory or X-Y positions of the trajectory be returned together with the textual output in the tool's overall output, response or result.

An AI tool or model as described herein may be implemented one or more pretrained artificial neural networks. In comparison, non-AI tools may include those implemented without using any AI model or artificial neural network. For example, a non-AI tool may be implemented with classical computer vision based techniques based on edge detection or depth data. Non-AI tools may be implemented as functions, APIs, libraries or applications that can access internal or external data sources (e.g., in realtime, online, offline, etc.) such as realtime weather information, road conditions, etc.

### 2.2. Pretraining and Fine-Tuning

The term “pretraining” or “pretrained” here may refer to training an AI tool or model prior to the AI tool or model being incorporated into the framework or system as illustrated in FIG. 1. For example, the core model 104 may have been pretrained before it is incorporated into the framework or system with the tools. In other words, the pretraining of the core model 104 may have been performed independent of (e.g., any interactions with, etc.) the tools 106. Likewise, AI models or tools in the tools 106 may have been pretrained before they are incorporated into the framework or system with the trained or pretrained core model 104. Hence, the pretraining of the AI models or tools in the tools 106 may have been performed independent of (e.g., any interactions with, etc.) the core model 104.

In comparison with “pretraining”, the term “fine-tuning” or “fine-tuned” may refer to training an AI model after the AI model has been incorporated into the framework or system as illustrated in FIG. 1. For example, (e.g., only, etc.) the trained or pretrained core model 104 may be further trained or fine-tuned after it has been incorporated into the framework or system with the tools 106. Hence, the fine-tuning of the trained or pretrained core model 104 may be performed at least in part dependent on the model's interactions with the tools 106 in the same framework or system. In some operational scenarios, no fine-tuning or training is performed to the AI models or tools 106 after these AI models or tools have bene incorporated into the framework or system as illustrated in FIG. 1.

As used herein, unless specific contexts or temporal relationships indicate otherwise, the term “training” may refer to either pretraining or fine-tuning.

In a fine-tuning phase, the core model 104 can be fine-tuned or trained to select, based at least in part on query or question received, specific tools (e.g., correctly, predictably, etc.) in the tools 106 and/or call/invoke specific functions (e.g., correctly, predictably, etc.) with specific arguments or inputs supported by functions, APIs or libraries, applications in the tools 106. The core model 104 can also be fine-tuned or trained to summarize responses or results from the specific tools or functions supported by the functions, APIs or libraries, applications in the tools 106 and generate final response(s) based at least in part on the summarized responses or results.

### 2.3. Fine-Tuning for Tool Calling

As noted, the core model 104 has been training or pretraining before its incorporation into the overall model that includes both the core model 104 and the tools 106.

Due to this pretraining, the core model 104 already possesses AI/ML based multimodal language chatbot capabilities before its incorporation into the overall model represented by the (e.g., fine-tuned, etc.) combination of the core model 104 and the tool 106. For example, in some operational scenarios, the core model 104 is capable of receiving multimodal input such as a combination of text prompt and image, extracting input features from the received multimodal input, and applying the extracted input features as input to trained or pretrained AI modules or algorithms to perform one or more AI implemented operations such as AI-based predictions, estimations, classifications, regression, reasoning, etc., thereby generating the core model's response based on the received multimodal input. However, as noted, the core model may be prone to hallucinating if the multimodal input relates to specific contexts, domains or applications for which the core model does not possess relatively reliable or accurate skills.

As noted, the core model 104 may be fine-tuned or further trained (e.g., trained to specifically operate with the tools 106, etc.) after the core model's incorporation into the overall model that includes both the core model 104 and the tools 106.

Due to this fine-tuning, the core model 104 enhances its AI/ML based multimodal language chatbot capabilities in comparison with its previous chatbot capabilities before its incorporation into the overall model. For example, in some operational scenarios, the core model 104 remains capable of receiving multimodal input such as a combination of text prompt and image, extracting input features from the received multimodal input, and applying the extracted input features as input to trained or pretrained AI modules or algorithms to perform one or more AI implemented operations such as AI-based predictions, estimations, classifications, regression, reasoning, etc., thereby generating the core model's response based on the received multimodal input.

To eliminate or significantly reduce the core model's hallucination tendency, the core model 104 is now fine-tuned to operate in conjunction with the tool106 in operational scenarios in which multimodal inputs from users may involve or implicate specific tools (and/or functions, APIs or libraries, applications) for which the core model 104 on its own may lack sufficient skills or training to provide relatively accurate or reliable responses or outputs.

The core model 104 may be specifically fine-tuned to recognize or identify (e.g., fine-tuned to automatically classifying, etc.) specific contexts, domains or applications-relating to one or both of the received multimodal input or the core model's response-for which the core model does not possess relatively reliable or accurate skills on its own; determine one or more specific tools (and/or functions, APIs or libraries, applications) in the tools 106 corresponding to the specific contexts, domains or applications; to generate or establish one or more intermediate inputs to the one or more specific tools (and/or functions, APIs or libraries, applications) based at least in part on one or both of the received multimodal input or the core model's response; to call or invoke the one or more specific tools (and/or functions, APIs or libraries, applications) in the tools 106 with the one or more intermediate inputs, respectively; to receiving results or outputs from the one or more specific tools (and/or functions, APIs or libraries, applications) in the tools 106; to generate an overall response to the user's multimodal input based at least in part on the results or outputs from the one or more specific tools (and/or functions, APIs or libraries, applications) in the tools 106; to return the overall response to the user, for example by way of text alone or by way of a multimodal output that may include text, image, etc. ; and so on.

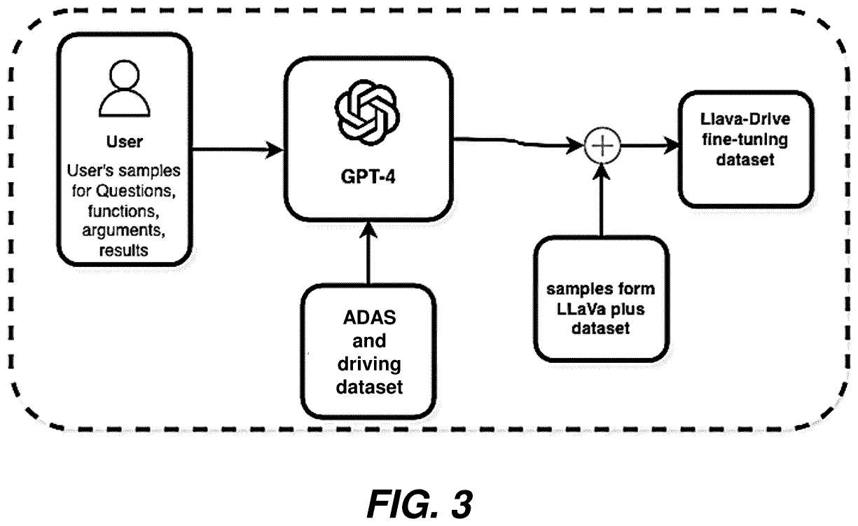

In some operational scenarios, new tools (and/or functions, APIs or libraries, applications) can be added into the tools 106 on an ongoing basis (e.g., every now and then, periodically, scheduled, on demand, etc.) at multiple times or occasions. For the new tools in the tools 106, new fine-tuning (training) data can be generated (e.g., as illustrated in FIG. 3, etc.) to fine-tune or train the core model to operate with the new tools (and/or functions, APIs or libraries, applications).

In comparison, it may be permitted but is not necessary to generate new fine-tuning (training) data to fine-tune or train the core model 104 to operate with existing tools with which the core model 104 have already been fine-tuned or trained.

Existing fine-tuning (training) data that has been used to train the core model 104 or a backbone portion implemented therein to operate correctly or relatively accurately with these existing tools in the tools 106 and/or other existing tools (and/or functions, APIs or libraries, applications) outside the tools 106 may be sampled (e.g., 1-5% of the total existing training data volume, etc.). The sampled existing fine-tuning (training) data may be used in the overall or final fine-tuning (training) data used to train the core model 104 or the backbone portion to operate with the new tools as well as to remember how or retain the previously learned knowledge to operate with the existing tools in the tools 106 and/or other existing tools (and/or functions, APIs or libraries, applications) outside the tools 106. Here, the backbone portion of the core model 104 may refer to system modules or components that implement core functions or backend functions of the core model 104.

In some operational scenarios, a diverse set of callable tools can be generated for a core or vision language model as described herein. Each of these tools may be defined as a self-contained service or library with a well-specified or preconfigured API, regardless of whether the tool includes or wraps a deep learning routine (e.g., implemented with deep or artificial neural networks, etc.), a non-AI/ML computer vision algorithm, or a non-vision utility. A small “stub” or interface definition can be specified for each such tool—for example, in OpenAPI or as a Python function signature—and declares specific types of inputs (e.g., images, text prompts, parameters, etc.) the tool is to receive and specific types of outputs (e.g., bounding boxes, classification labels, numerical metrics, etc.) the tool returns.

Core logic can then be implemented with the core model in compliance with the specified types of inputs or outputs. In some operational scenarios, the core logic can be implemented to containerize AI-based tools, functions, APIs, applications or methods (e.g., implemented with deep or artificial neural networks, etc.). Additionally, optionally or alternatively, the core logic can be implemented to package, group or interact with some or all of these tools, functions, APIs, applications or methods using one or more lightweight modules as well as to ensure that each of these tools, functions, APIs, applications or methods can be invoked programmatically (e.g., via an HTTP endpoint or a Python import, etc.).

Each of these tools can be registered with a central tool registry or metadata catalog that the core model or VLM can query at runtime. The registry holds each tool's name, signature, and endpoint. At inference time, when the core model or VLM parses a user request, the core model can look up one or more matching tools in the registry, call corresponding APIs of these matching tools with decoded inputs generated from a multimodal input from a user or agent, receives the raw output from the called matching tools, and then uses its language head or functionality to convert that raw output into a concise, user-friendly summary return to the user or agent.

These tools can be any functions or open source packages released online, or an AI model which may be trained from the scratch with public, standard and/or proprietary training data and/or training data developed or taken from open source data. Additionally, optionally or alternatively, some or all pre-trained tools or models may be fine-tuned with fine-tuning training data to operate with the core model. Additionally, optionally or alternatively, non-AI tools or methods using non-AI computer vision techniques such as for edge detection may be used or incorporated into a framework as described herein to interoperate with the core model or VLM.

### 2.4. Tools and Functions

For the purpose of illustration but not limitation, a core model (e.g., 104 of FIG. 1, etc.) implemented as a LlaVa-Plus model may be fine-tuned with (e.g., a tools 106 of FIG. 1 of, etc.) one or more tools. These tools may be new to the pretrained core model 104 and include a specific tool denoted as “Object Reader.”

This “Object Reader” tool has been pretrained to possess a specific skill to relatively (or highly) accurately read signages, alphabet, numeric characters located on specific visual objects captured in images in response to or based on users'queries or questions. This specific tool may be used by, or may operate with, the core model 104 to read specific speed limit value on speed limit signs in visual objects of the images. More specifically, while the core model 104 or the LLaVa-plus model is not capable of answering all questions about speed limit values, the model can be fine-tuned to access or use the specific “Object Reader” (e.g., new to the pretrained core model, etc.) tool—e.g., call or invoke the tool with a multimodal input or argument, obtain relatively accurate and reliable results/answers from the tool in return, and summarize the results/answers into a final response or output to a (human) user or a computer-implemented agent (e.g., relating to autonomous driving or automatic driver assistance, etc.).

To fine-tune or train the core model 104 to operate with the (e.g., new to the pretrained core model, etc.) “Object Reader” tool, fine-tuning (training) data may be generated based at least in part on user input from a large language model (LLM) such as GPT-4 as illustrated in FIG. 3. The LLM or GPT-4 can be used to generate the fine-tuning (training) data as a dataset of conversations to be used to fine-tune or train the pretrained core model 104 for operating with or using the (e.g., new to the pretrained core model, etc.) tool. In order to avoid having a high bias or propensity to calling or invoking the new tool unnecessarily, the dataset of conversations or fine-tuning (training) data may be merged or added with (e.g., sampled, etc.) portion of previous training data (conversations) used to train or pretrain the core model 104, as will be further explained in detail later with FIG. 3. This helps the core model 104 to retrain its existing skills or to still remember how to use its existing skills.

At the end of fine-tuning the core model 104 to operate with the new tool, tests may be performed with the core model 104 using a test (data) set to verify or validate whether the core model 104 can invoke or call the new tool correctly depending or based on a user's query or question. At the end of fine-tuning and testing, the core model 104 can be observed to make use of this new “Object Reader” tool correctly depending or based on a user's query or question. The new tool can help the core model 104 to answer domain specific queries or questions with relatively accurate responses or answers.

Multiple tools, functions, APIs, libraries, or applications may be added as external tools such as 106 of FIG. 1 to interoperate with the core model 104. Any, some or all of these tools or the like can be added into the tools 106 concurrently or at least in part sequentially. Additional (e.g., new, etc.) fine-tuning training data such as additional (e.g., new, etc.) conversations may be generated from the LLM or GPT-4 based at least in part on additional (e.g., new, etc.) user inputs or multimodal inputs. In some operational scenarios, the core model 104 can operate with such a tools 106 of tools to implement a framework or system (denoted as “Llava-drive”) that can be used in a wide range of ADAS and driving domains to support relatively accurate or reliable understanding of visual surrounding and spatial reasoning (e.g., captured by vehicle or ego based cameras, LIDAR or other physical sensors, etc.).

To avoid or eliminate any bias or propensity to calling or invoking the most recently added tools unnecessarily, fine-tuning (training) data for the most recently added tools in the tools 106 or repository may be merged or added with (e.g., sampled, etc.) portion of previous training data (conversations) used to train or pretrain the core model 104 to retrain its capabilities to operate with existing tools or to still remember how to use these existing tools. As a result, the core model 104 can be fine-tuned to operate with for a set, pool or repository of new and existing tools in a relatively accurate and reliable way, ensuring that no existing ability of the core model 104 or the existing tools will be lost in the (fine-tuning) process.

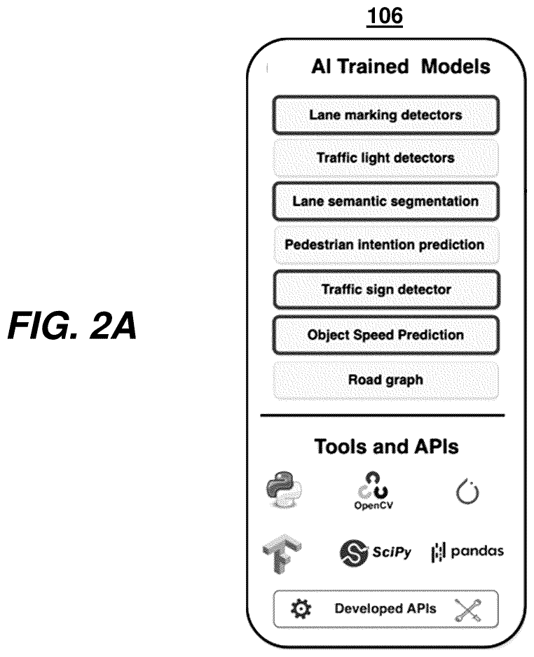

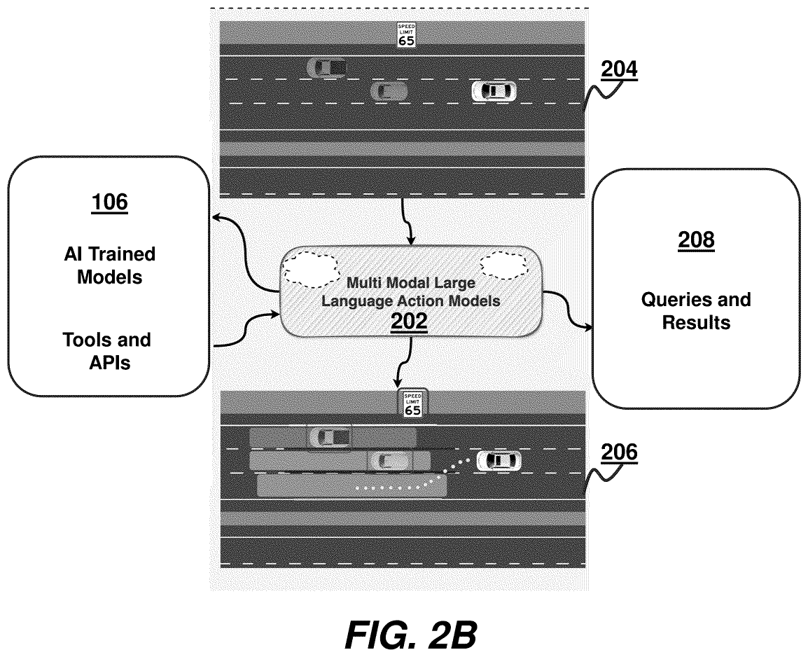

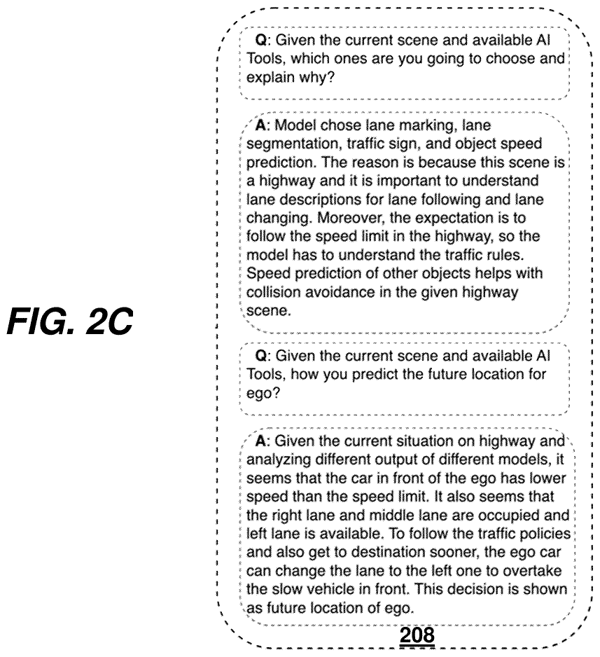

FIG. 2A illustrates example tools (and/or functions, APIs, libraries or applications) relating to vehicle driving or ADAS. The vehicle driving or ADAS tools can be both AI and non-AI tools that together provide a relatively complete coverage or range for some or all ADAS related skills, contexts, domains or applications.

A user or agent can obtain relatively accurate or reliable results or outputs needed by vehicle driving or ADAS operations including but not limited to vehicle propulsion operations. The tools 106 can be used to complement a relatively generic (ADAS tool calling) VLM or core model (e.g., 104 of FIG. 1, etc.). The core model operating with the tools 106 can help or assist users in the self-driving, driver assistant or autonomous domain to have a relatively high quality visual and contextual understanding of a current operational scenario relating to vehicle driving.

AI tools may be trained or pretrained before operating or being integrated with a core model (e.g., 104 of FIG. 1, etc.) without further fine-tuning. For example, each of the AI tools may have been trained—in a model training phase preceding their integration with the core model 104 to operate or make predictions in a model application or inference phase—with training data including training images, training textual input, ground truths, human or non-human annotated training data, etc. In some operational scenarios, an AI tool as described herein may be trained using a reward system that does not rely (e.g., entirely, etc.) on ground truth being available for training data such as training images.

Example ADAS AI tools or models as described herein may include, but are not necessarily limited to only, any, some or all of: land marking detectors, traffic light detectors, lane semantic segmentation (tools), pedestrian intention prediction (tools), traffic sign detector(s), object speed prediction (tools), road graph (tools), and so on.

The tools 106 may include non-AI tools, computer implemented functions, APIs, libraries or applications as represented by various graphic icons (e.g., TensorFlow, Python, OpenCV, etc.) in FIG. 2A. These non-AI tools and functions, APIs, libraries or applications may or may not be specifically implemented for ADAS application or application areas, so long as they can be invoked or used to complement the core model 104 or other tools in the tools 106 for the purpose of generating relatively reliable or accurate results or outputs suitable for ADAS operations.

A user 102 such as shown in FIG. 1 may interact with the core model 104 operating with the tools 106 in a single exchange of input and output or in a conversation that involves one or more exchanges of inputs and outputs. Any, some or all of these inputs and outputs may be textual only or multimodal such as involving both texts and images.

### 2.5. Multimodal Input and Textual Output

As illustrated in FIG. 1, the user 102 may be interacting with a computer implemented user interface to provide a multimodal (language) input to the core model 104, for example implemented as a LLaVa-Plus VLM fine-tuned for tool calling. The multimodal input may include the user's textual query/prompt 108 and an image 110 (or a video clip with multiple images depicting the same scene) of a road section.

While the image 110 of the road section may include speed limit visual depiction such as a visual object representing a speed limit sign posted on the road section, the core model 104 may not—at least not reliably or accurately—have been trained to identify visual objects representing speed limit signs on road sections and to associate the visual objects or image details such as numbers captured therein with speed limits. The user's textual query/prompt 108 may be a question for how fast the user's car should be, given this image 110 depicting what is in the road section ahead of the car.

The core model 104 could have used its pretrained chatbot capabilities and general tools—which are not capable of producing responses for critical applications or application areas such as ADAS and vehicle driving—to generate a response to this type of multimodal input. However, this response would likely have been inaccurate or unreliable. As the core model 104 had not specifically been trained for critical applications or application areas such as vehicle driving, such a response would likely be inaccurate or even hallucinating to some extent. For example, the response may indicate an incorrect speed limit of 55 miles per hour instead of an accurate speed limit of 65 miles per hour on a road section.

Under techniques as described herein, the core model 104 has been specifically fine-tuned to operate with the tools for critical applications or application areas such as vehicle driving. Moreover, the core model 104 has been fine-tuned to recognize or identify (e.g., fine-tuned to automatically classifying, etc.) specific contexts, domains or applications relating to one or both of the received multimodal input or the core model's response, for which the core model does not possess relatively reliable or accurate skills on its own. The core model 104 has been further fine-tuned to determine one or more specific tools in the tools 106 corresponding to the specific contexts, domains or applications.

In the present example, the core model 104 may have been fine-tuned to identify a specific tool (denoted as “object detection”) in the tools 106 to be relating to the specific context, domain or application for determining speed limits based on images.

Accordingly, the core model 104 may have been fine-tuned to perform an operation such as tool calling 112 to invoke the specific tool “object detection” with an intermediate input generated or established by the core model 104 based at least in part on one or both of the received multimodal input or the core model's response.

The intermediate input may include the user's initial query (or any, some or all follow-on queries) and non-textual data such as the road section image containing the visual object depicting the speed limit sign. Additionally, optionally or alternatively, the intermediate input may include an initial (or intermediate) response generated by the core model 104 from the input road section image in the user's multimodal input.

For the purpose of illustration, the specific tool “object detection” in the tools 106 has been pretrained (e.g., before being integrated into the overall framework to operate with the core model 104, etc.) to handle questions or queries relating to speed limits based on road section images and/or related textual queries/prompts. Hence, this “object detection” tool in the tools 106 without further fine-tuning can be invoked or called with an input or argument to determine on its own the speed limits relatively reliably and accurately based at least in part on the input or argument received by the “object detection” tool.

In the present example, responsive to receiving the intermediate input or an argument generated or established by the core model 104 based at least in part on one or both of the user's multimodal input or the core model's (initial or intermediate) response, the “object detection” tool in the tools 106 (e.g., without fine-tuning, etc.) can process the received intermediate input received as an argument from the core model, detect the visual object relating to the speed limit, read out from the image details depicting the numbers in the visual object and generate a tool response 114—which may be a result or output indicating a number or text for the detected speed limit for the road section—sent back to the core model 104.

Upon receiving the tool response 114 from the “object detection” tool in the tools 106, the core model 104 can generate an overall or final response 116 to the user's multimodal input based at least in part on the result or output from the “object detection” tool in the tools 106. For example, the core model may process the result or output from the “object detection” tool in the tools 106 and summarize it with its own initial or intermediate response to generate the overall or final response 116. The overall or final response 116—which in the present example may be textual information indicating the speed limit—may be returned, presented or provided to the user by way of the computer implemented user interface.

For the purpose of illustration, it has been described that the core model 104 can call or invoke a tool in the tools 106 of tools in response to receiving a user's multimodal input and/or in response to generating an intermediate or initial response to the user's multimodal input. It should be noted that in other operational scenarios, the core model 104 may call or invoke multiple tools in the tools 106 in parallel or in series at least in part in response to receiving a user's multimodal input and/or in response to generating an intermediate or initial response to the user's multimodal input. In an example, the multiple tools may be called or invoke in parallel, either with the same argument or input or with different arguments or inputs from the core model. In another example, the multiple tools may be called or invoke in parallel, for example with successively different arguments or inputs; these different arguments or input may be generated and provided by the core model based on received results or outputs from previous tools among the called or invoked tools. In a further example, some of the multiple tools may be called or invoked in parallel with the same or different arguments or inputs from the core model, while others of the multiple tools may be called or invoked in series with the same or different arguments or inputs from the core model.

### 2.6 Multimodal Input and Output

FIG. 2B in combination with FIG. 2A and FIG. 2C illustrates example operations of a core model as described herein such as 104 of FIG. 1 or FIG. 2B operating with tools (and/or functions, APIs, libraries or applications, 106 of FIG. 1, FIG. 2A, FIG. 2B, etc.). The core model 104 and the tools operate together to generate or return multimodal outputs based on user's multimodal inputs, for example in a single exchange or in a conversation that involves multiple exchanges.

In some operational scenarios, the user 102 of FIG. 1 may be interacting with the computer-implemented user interface to provide a multimodal (language) input to the core model 104. The multimodal input may be processed by the core model which implements or includes a multi modal large language (action) model 202 (e.g., a LLaVa-Plus VLM, etc.) that has been fine-tuned for ADAS tool calling (e.g., calling tools in the tools 106 of ADAS tools illustrated in FIG. 2A, etc.).

The multimodal input may include the user's textual query/prompt and a highway scene 204. The user's textual query/prompt may be a textual question “Q: Given the current scene and available AI Tools, which ones are you going to choose and explain why?” as illustrated in FIG. 2C.

While the highway scene 204 may include visual road/traffic lane depiction, the core model 104 may not—at least not reliably or accurately—have been trained to identify lanes and to suggest trajectory on road sections.

The core model 104 could have used its pretrained chatbot capabilities and general tools—which are not capable of producing responses for critical applications or application areas such as ADAS and vehicle driving—to generate a response to this type of multimodal input. However, this response would likely have been inaccurate or unreliable. As the core model 104 had not specifically been trained for critical applications or application areas such as vehicle driving, such a response would likely be inaccurate or even hallucinating to some extent. For example, the response may not be able to indicate a correct number of available lanes or their respective boundaries on a road section, or to suggest a candidate trajectory for a vehicle (which may be referred to as “ego”).

Under techniques as described herein, the core model 104 has been specifically fine-tuned to operate with the tools for critical applications or application areas such as vehicle driving as illustrated in FIG. 2C.

Moreover, the core model 104 has been fine-tuned to recognize or identify (e.g., fine-tuned to automatically classifying, etc.) specific contexts, domains or applications relating to one or both of the received multimodal input or the core model's response, for which the core model does not possess relatively reliable or accurate skills on its own.

The core model 104 has been further fine-tuned to determine one or more specific tools in the tools 106 corresponding to the specific contexts, domains or applications.

In the present example, the core model 104 may have been fine-tuned to identify a set of specific tools (and/or functions, APIs, libraries or applications) in the tools 106 to be relating to the specific context, domain or application for detecting and demarcating lanes in road sections or scenes and generating or suggesting trajectories of vehicles or egos based on road graph images. As illustrated in FIG. 2A, the set of specific tools for detecting and demarcating lanes and generating or suggesting trajectories may include one or more of: lane marking detectors, lane semantic segmentation, traffic sign detector, object speed prediction, etc.

Accordingly, the core model 104 may have been fine-tuned to generate a textual response or answer—“A: Model chose lane marking, lane segmentation, traffic sign, and object speed prediction. The reason is because this scene is a highway and it is important to understand lane descriptions for lane following and lane changing. Moreover, the expectation is to follow the speed limit in the highway, so the model has to understand the traffic rules. Speed prediction of other objects helps with collision avoidance in the given highway scene” as illustrated in FIG. 2C-to the multimodal input or question from the user 102.

In the present example, responsive to receiving the response or answer from the core model 104, the user may further interact with the computer-implemented user interface to provide a textual query/prompt to the core model 104, which may be a second textual question “Q: Given the current scene and available AI Tools, how you predict the future location for ego?” as illustrated in FIG. 2C.

Accordingly, the core model 104 may have been fine-tuned to perform an operation such as tool calling 112 to invoke some or all of the specific tool “object detection” with an intermediate input generated or established by the core model 104 based at least in part on one or both of the received user inputs or the core model's response(s). The intermediate input may include arguments/inputs generated from one or more of the user's initial or follow-on queries or questions and non-textual data such as the highway scene/image. Additionally, optionally or alternatively, the intermediate input may include the initial (or intermediate) response generated by the core model 104 including any processed image generated by the core model 104 from the highway scene/image in the user's multimodal input.

As the specific tools in the tools 106 has been pretrained to handle questions or queries relating to (different aspects of) vehicle driving on road or highway sections based on highway scenes and/or road section images and/or related textual queries/prompts, these tools in the tools 106 (e.g., without further fine-tuning, etc.) can be invoked or called with respective inputs or arguments generated or prepared by the core model 104 (after fine-tuned) to generate respective results or outputs relating to (different aspects of) highway or road section vehicle driving relatively reliably and accurately based at least in part on the input or argument received by these tools.

In the present example, in response to receiving the inputs or arguments (e.g., correctly formatted, etc.) generated or established by the core model 104, the specific tools in the tools 106 (e.g., without fine-tuning, etc.) can process the received inputs or arguments from the core model, perform respective operations or predictions or analysis on the inputs or arguments relating to (different aspects of) highway or road section vehicle driving and generate tool responses sent back to the core model 104.

In response to receiving the tool responses from the specific tools in the tools 106, the core model 104 can generate an overall or final response. For example, the core model may process the results or outputs from the tools in the tools 106—which may include a marked up highway or road section lane graph indicating boundaries of lanes and a generated, predicted or suggested trajectory of a related vehicle or ego on the highway or road section and summarize the tool responses to generate the overall or final response. The overall or final response returned to the user or agent may be multimodal. In the present example, the overall or final response may include the marked up highway or road section lane graph as well as a textual response or answer—“A: Given the current situation on highway and analyzing different output of different models, it seems that the car in front of the ego has lower speed than the speed limit. It also seems that the right lane and middle lane are occupied and left lane is available. To follow the traffic policies and also get to destination sooner, the ego car can change the lane to the left one to overtake the slow vehicle in front. This decision is shown as future location of ego” as illustrated in FIG. 2C.

### 2.7. Fine-Tuning Training Data Generation

FIG. 3 illustrates example operations to generate or create training data for fine-tuning the core model in a fine-tuning phase to operate with the tools 106 of tools after the core model 104 of FIG. 1 and the AI tools/models in the tools 106 of tools have been pretrained.

In some operational scenarios, a pretrained LLM (e.g., other than the core model 104, etc.) may be used to generate fine-tuning (training) data including queries, arguments, functions, conversations for the purpose of fine-tuning or training the core model (e.g., VLM, etc.). For the purpose of illustration only, the LLM used to generate the fine-tuning (training) data may be, but is not necessarily limited to only, GPT-4, which is capable of in-context learning.

A user can interact with the LLM or GPT-4 to provide a relatively small number of examples or samples with corresponding instructions specifying questions, functions, arguments, results, etc., related to calling or invoking each specific tool in the tools 106. These examples or samples can include a relatively number of user's prompts (or samples/examples) and a relatively small number of corresponding training images.

The relatively small number of training images may constitute a subset of training images in a set of a relatively large number of training images. The set of a relatively large number of training images may be derived in part or in whole from one or more public or private training data sets, for example up to two thousand or more images of different road or highway scenes or lane graphs involving vehicle driving from public or private ADAS and driving datasets—including, but not necessarily limited to, NO2 and NO3 ADAS and driving data sets. Training images may include speed limit sign images (or images containing image details depicting speed limit signs). Training images may include road or highway scenes, lane graphs, obstacles, pedestrians, sidewalks, work sites, etc.

The user's prompts may include (e.g., textual, etc.) questions, queries, instructions, functions, arguments, results, etc., relating to calling specific tools in the tools 106 with this subset of training images. The user's prompts—which may include various questions or queries to be asked for each of the training images along with some or all of tools, functions, APIs, libraries or applications to be called or invoked, arguments to be passed or generated, results to be expected, etc.—may be placed in one or more textual files.

In some operational scenarios, a user may interact with some or all pretrained tools, functions, APIs, libraries or applications to be incorporated in the tools 106 the ground truth data for determining specific inputs or arguments to be expected in the calls or invocation of the tools, functions, APIs, libraries or applications as well specific outputs or results to be expected from the invoked/called tools, functions, APIs, libraries or applications. Some or all of the specific inputs or arguments and specific outputs or results may be used to interact with the LLM or GPT-4 to generate some or all of the fine-tuning (training) data.

The LLM or GPT-4 can implement or apply in-context learning capabilities to learn from the relatively small number of examples or samples to select specific tools in the tools 106, to formulate calls or invocations to the selected tools with corresponding questions, functions, arguments, etc., to understand contents, structures and formats, of responses, outputs or results, and to summarize or convert the responses, outputs or results from the selected tools into final responses, outputs or results.

In an example, a user's sample or example may include a question asking how many lanes on a road section of a scene depicted in a (e.g., training, etc.) image. In another example, a user's sample or example may include another question (e.g., in the same or different conversion as the question in the previous example, etc.) asking what speed limit is on the road section or what future trajectory is for a vehicle.

In addition to questions/queries, the user's sample or example may include user provided or system generated directions or expectations to call or invoke specific tools, functions, etc., respectively, for each of these questions. The user's sample or example may include user provided or system generated expectations or directions to generate correct arguments or inputs to be used in the call or invocation.

The LLM or GPT can learn from the samples or examples in an appropriate context. Through dialogs, conversions, sections or windows in the dialogs or conversations with the user, the LLM or GPT can learn what contexts, domains or applications, as expected by the user, are related to the queries or questions; what tools or functions are to be called or invoked to address the queries or questions; what inputs or arguments are to be passed or provided in the invocation or calling of these tools or functions; what outputs or result are to be returned from these tools or functions; how to summarize or format the outputs or results for the user; and so on.

For example, the user/system expectations or directions may indicate that a speed limit sign image detail should be used as an argument of a call or invocation of a speed limit reader tool. The user's sample or example may include expectations or directions to process or summarize results or outputs from specific tools, functions, etc. For example, the user's sample or example may include expectations or directions to look for specific speed limit values such as 55 mph or 65 mph.

The LLM or GPT-4 can use this knowledge—learned from the relatively small number of examples or samples-to generate a wider or broader fine-tuning (training) data, for example using the relatively large number of training images and/or related data in the ADAS and driving dataset(s). For example, from a user's question, the LLM or GPT-4 may expand into (e.g., a longer list of, etc.) different questions asked in different ways or formats or permutations that are similar or equal to the user's question. These different questions can be used to fine-tune or train the core model 104 of FIG. 1 to better recognize and process questions that may have the same overall meaning or purpose or intent.

Additionally, optionally or alternatively, the fine-tuning (training) data generated at least in part based on the responses, outputs or results from the LLM or GPT-4 can be passed through a computer-implemented filter to rank, prune, obtain or generate relatively high quality responses, outputs or results.

Sometimes the initial results—which may be a relatively large dataset-that the LLM or GPT-4 generates for the fine-tuning (training) data may contain questions and/or other data that are incorrect, or incomplete, or results of hallucination, or incorrectly specify tools not in the tools 106 or not expected. Filtering rules or criteria may be set up or defined based at least in part on user input to filter out or remove such relatively low quality training data. The user may review a portion such as 2% of the initial results and determine whether the initial results contain wrong samples/examples for fine-tuning before setting up or defining some or all of the filtering rules or criteria to be applied to some or all of the initial results for the purpose of generating a relatively high quality and/or clean and/or low error and/or consistent version of fine-tuning (training) data.

In some operational scenarios, the filter may be specified in part or in whole with filtering rules or patterns set up based at least in part on user input from a human user or training data reviewer who has reviewed some or all of the fine-tuning (training) data generated by the GPT-4. The filtered relatively high quality responses, outputs or results along with their corresponding images can be combined into training multimodal inputs. The training multimodal inputs can be incorporated into the (e.g., filtered, relatively high quality, etc.) fine-tuning (training) data used to train the core model 104 of FIG. 1 to operate with the tools 106 of tools.

In some operational scenarios, the core model or VLM may have been pretrained (e.g., with GitHub LLaVa or LLaVa Plus training data, etc.) to operate with other (e.g., external, callable, etc.) tools other than those in the tools 106 or other tools already added into the tools 106, with which the core model 104 has already trained or fine-tuned to operate.

The previous training data (denoted as “LLaVa plus dataset” in FIG. 3) used to pretrain the core model or VLM to operate with these other tools may be of a relatively huge data volume and may be sampled (e.g., amounting to 1-5% of the previous training data volume, up to 1000 or 5000 samples, etc.). While the sample data is not necessarily related to any new specific tools to be newly added into the tools 106, it can help the core model 104 to retain or remember its previously trained capability to operate with the other tools other than those in the tools 106 or other tools already added into the tools 106, with which the core model 104 has already trained or fine-tuned to operate.

The (e.g., user, system automatically, with a fixed seed value, with a randomly selected seed value, etc.) sampled previous training data may be combined into finalized fine-tuning (training) data (denoted as “Llava-Drive fine-tuning dataset” in FIG. 3) used to train the core model 104 of FIG. 1 to operate with the tools 106 of tools as well as the other tools outside or not in the tools 106.

As described herein, the finalized fine-tuning (training) data may be automatically generated with no or little human annotation once the user's samples or examples are provided along with images or related data in the ADAS and/or driving dataset(s) to the LLM or GPT-4 and/or the rules for filtering are determined possibly with user input. In some operational scenarios, however, the finalized fine-tuning (training) data may be partly annotated or enhanced by human input.

A subset or portion of the finalized fine-tuning (training) data may be used as test data—in a fine-tuning phase or trained or a test phase following the fine-tuning phase in which the core model is fine-tuned—to determine whether the core model (104 of FIG. 1) is capable of operating with the tools (106 of FIG. 1). Additionally, optionally or alternatively, instead of using a subset or portion of the finalized fine-tuning (training) data, such test data may be separately prepared or generated by performing similar operations using similar inputs to those performed or used to generate the finalized fine-tuning (training) data.

### 3.0. Example Process Flows

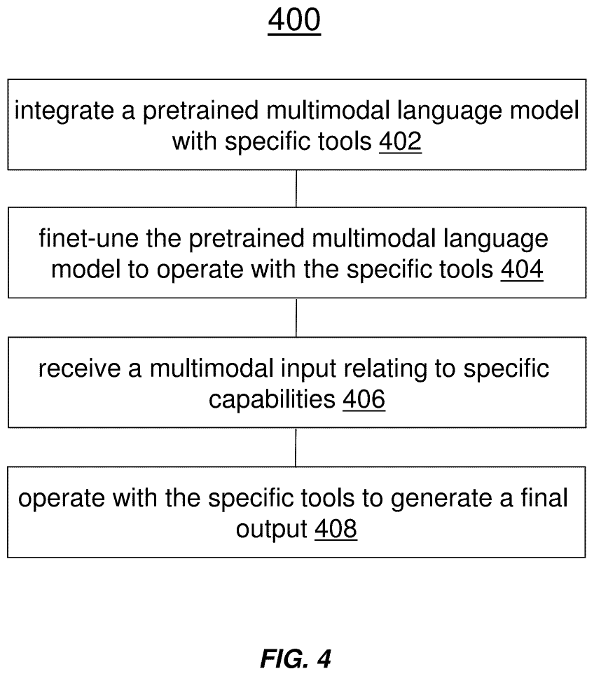

FIG. 4 illustrates an example process flow 400 according to an embodiment. In some embodiments, one or more computing devices or components may perform this process flow. In block 402, a pretrained multimodal language model is integrated with one or more specific tools specializing in one or more specific capabilities which the pretrained multimodal language model lacks.

In block 404, the pretrained multimodal language model is pretrained to operate with the one or more specific tools based at least in part on fine-tuning training data generated with a large language model separate from the pretrained multimodal language model.

In block 406 the fine-tuned pretrained multimodal language model receives a multimodal input relating to the one or more specific capabilities which the multimodal language model lacks.

In block 408, the fine-tuned pretrained multimodal language model operates with at least one of the one or more specific tools to generate a final output based at least in part on the multimodal input received by the fine-tuned pretrained multimodal language model.

In an embodiment, the multimodal input includes two or more of: text, image, video, audio, graphics or non-textual data.

In an embodiment, the one or more specific tools belongs to external tools that operate with the pretrained multimodal language model after fine-tuning the pretrained multimodal language model to operate with the tools.

In an embodiment, the fine-tuning training data includes one or more portions of previous fine-tuning training data used to train the multimodal language model with one or more other tools other than the one or more specific tools.

In an embodiment, the large language model separate from the pretrained multimodal language model represents a GPT-4 model.

In an embodiment, the multimodal input and the final output are a part of an overall conversation between one of a user or agent and the fine-tuned pretrained multimodal language model.

In an embodiment, the fine-tuned pretrained multimodal language model calls the one or more specific tools with specific arguments generated based at least in part on the multimodal input.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 4.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

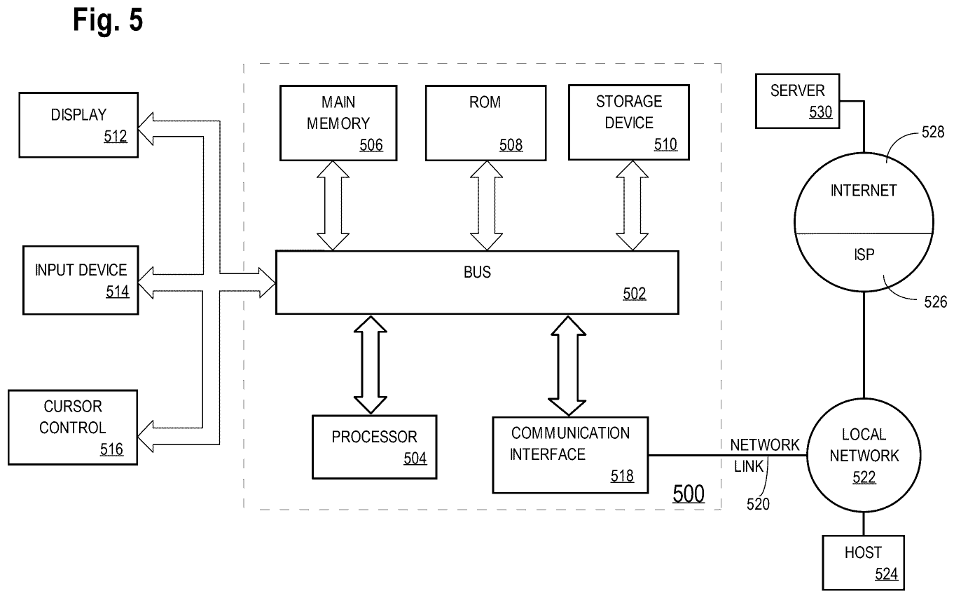

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud” based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 5.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
integrating a pretrained multimodal language model with one or more specific tools specializing in one or more specific capabilities which the pretrained multimodal language model lacks;
fine-tuning the pretrained multimodal language model to operate with the one or more specific tools based at least in part on fine-tuning training data generated with a large language model separate from the pretrained multimodal language model;
receiving, by the fine-tuned pretrained multimodal language model, a multimodal input relating to the one or more specific capabilities which the multimodal language model lacks;
operating, by the fine-tuned pretrained multimodal language model, with at least one of the one or more specific tools to generate a final output based at least in part on the multimodal input received by the fine-tuned pretrained multimodal language model.

2. The method of claim 1, wherein the fine-tuned pretrained multimodal operates with the one or more specific tools to identify one or more of: lane marking, lane segmentation, traffic sign, vehicle trajectory prediction or object speed prediction.

3. The method of claim 1, wherein the multimodal input includes two or more of: text, image, video, audio, graphics or non-textual data.

4. The method of claim 1, wherein the one or more specific tools belongs to external tools that operate with the pretrained multimodal language model after fine-tuning the pretrained multimodal language model to operate with the tools.

5. The method of claim 1, wherein the fine-tuning training data includes one or more portions of previous fine-tuning training data used to train the multimodal language model with one or more other tools other than the one or more specific tools.

6. The method of claim 1, wherein the large language model separate from the pretrained multimodal language model represents a GPT-4 model.

7. The method of claim 1, wherein the multimodal input and the final output are a part of an overall conversation between one of a user or agent and the fine-tuned pretrained multimodal language model.

8. The method of claim 1, wherein the fine-tuned pretrained multimodal language model calls the one or more specific tools with specific arguments generated based at least in part on the multimodal input.

9. One or more non-transitory computer readable media storing a program of instructions that is executable by one or more computing processors to perform:
integrating a pretrained multimodal language model with one or more specific tools specializing in one or more specific capabilities which the pretrained multimodal language model lacks;
fine-tuning the pretrained multimodal language model to operate with the one or more specific tools based at least in part on fine-tuning training data generated with a large language model separate from the pretrained multimodal language model;
receiving, by the fine-tuned pretrained multimodal language model, a multimodal input relating to the one or more specific capabilities which the multimodal language model lacks;
operating, by the fine-tuned pretrained multimodal language model, with at least one of the one or more specific tools to generate a final output based at least in part on the multimodal input received by the fine-tuned pretrained multimodal language model.

10. The media of claim 9, wherein the fine-tuned pretrained multimodal operates with the one or more specific tools to identify one or more of: lane marking, lane segmentation, traffic sign, vehicle trajectory prediction or object speed prediction.

11. The media of claim 9, wherein the multimodal input includes two or more of: text, image, video, audio, graphics or non-textual data.

12. The media of claim 9, wherein the one or more specific tools belongs to external tools that operate with the pretrained multimodal language model after fine-tuning the pretrained multimodal language model to operate with the tools.

13. The media of claim 9, wherein the fine-tuning training data includes one or more portions of previous fine-tuning training data used to train the multimodal language model with one or more other tools other than the one or more specific tools.

14. The media of claim 9, wherein the large language model separate from the pretrained multimodal language model represents a GPT-4 model.

15. The media of claim 9, wherein the multimodal input and the final output are a part of an overall conversation between one of a user or agent and the fine-tuned pretrained multimodal language model.

16. The media of claim 9, wherein the fine-tuned pretrained multimodal language model calls the one or more specific tools with specific arguments generated based at least in part on the multimodal input.

17. A system, comprising: one or more computing processors; one or more non-transitory computer readable media storing a program of instructions that is executable by the one or more computing processors to perform:
integrating a pretrained multimodal language model with one or more specific tools specializing in one or more specific capabilities which the pretrained multimodal language model lacks;
fine-tuning the pretrained multimodal language model to operate with the one or more specific tools based at least in part on fine-tuning training data generated with a large language model separate from the pretrained multimodal language model;
receiving, by the fine-tuned pretrained multimodal language model, a multimodal input relating to the one or more specific capabilities which the multimodal language model lacks;
operating, by the fine-tuned pretrained multimodal language model, with at least one of the one or more specific tools to generate a final output based at least in part on the multimodal input received by the fine-tuned pretrained multimodal language model.

18. The system of claim 17, wherein the fine-tuned pretrained multimodal operates with the one or more specific tools to identify one or more of: lane marking, lane segmentation, traffic sign, vehicle trajectory prediction or object speed prediction.

19. The system of claim 17, wherein the multimodal input includes two or more of: text, image, video, audio, graphics or non-textual data.

20. The system of claim 17, wherein the one or more specific tools belongs to external tools that operate with the pretrained multimodal language model after fine-tuning the pretrained multimodal language model to operate with the tools.

21. The system of claim 17, wherein the fine-tuning training data includes one or more portions of previous fine-tuning training data used to train the multimodal language model with one or more other tools other than the one or more specific tools.

22. The system of claim 17, wherein the large language model separate from the pretrained multimodal language model represents a GPT-4 model.

23. The system of claim 17, wherein the multimodal input and the final output are a part of an overall conversation between one of a user or agent and the fine-tuned pretrained multimodal language model.

24. The system of claim 17, wherein the fine-tuned pretrained multimodal language model calls the one or more specific tools with specific arguments generated based at least in part on the multimodal input.
